(19) United States
(12) Patent Application Publication
(10) Pub. No.: US 2003/0205850 A1
(43) Pub. Date: Nov. 6, 2003

(54) Manufacture of magnetic tape under heat treatment and tension

(76) Inventors: Christopher J. Zwettler, Lake Elmo, MN (US); Matthew B. Kahle, Little Canada, MN (US)

Correspondence Address: Imation Corp., P.O. Box 64898, St. Paul, MN, 55164-0898, US

(21) Appl. No.: 10/428,615

(22) Filed: May 2, 2003

Related U.S. Application Data
(62) Division of application No. 09/669,073, filed on Sep. 25, 2000, now abandoned.

(51) Int. Cl. B29C 47/88

(52) U.S. Cl. 264/492; 264/40.6; 264/171.13; 264/210.2

(57) ABSTRACT

A method and apparatus for treatment of magnetic tape are disclosed. Magnetic tape may be dispensed from a first reel and taken up from a second reel, with the segment between the first and second reels held in tension while heat is applied. Magnetic tape that has been so treated will deform less during actual use.

### TECHNICAL FIELD

This invention relates to data storage media, and more particularly to the production of magnetic tape.

### BACKGROUND INFORMATION

Tape is a known medium for the storage of audio, video, and computer information. The information is typically written to and read from the tape magnetically and/or optically, but all such tape used to store information shall be treated as synonymous with the term “magnetic tape” as used herein. Such magnetic tapes are available spooled on individual reels and in single or dual reel tape cassettes/cartridges. The tape path for any type of tape cartridge and tape drive includes a tape head in close proximity to the magnetic tape. Tape cartridges may include an opening through which a tape head from a tape drive is inserted. The tape head has one or more transducer elements for writing to and/or reading from the magnetic tape. The magnetic tape is driven past the tape head by a belt-drive capstan, or by direct drive of the tape reels. Tape guides help position the tape relative to the tape head.

Magnetic tape typically includes a base film formed of material such as polyester. Base film is usually formed by an extrusion process. Following extrusion, the base film may receive a coating on both sides. The back side, i.e., the side of the tape that contacts the tape guides, may be coated with oxide wear particles and carbon in a polymeric binder. The front side, i.e., the side used for reading or writing of information, ordinarily receives a magnetic coating of iron oxide particles in a polymeric binder.

Cassettes or cartridges including magnetic tape are commonly used to back up computer information from all types of computer systems. This is especially Home computers also may be equipped with tape drives, which use tape cartridges to back up computer information. A primary usage for magnetic tape and tape cartridges is for the storage of vast amounts of data. In some instances, one or more tape cartridges may be used in a library that includes a tape drive coupled with a picking mechanism and a storage area storing a number of tape cartridges accessible by the picking mechanism. Magnetic tape drives typically use a reel-to-reel tape transport design, or “tape path,” for controllably advancing the magnetic tape past an adjacent tape head. The magnetic tape may be wound upon two reels, one reel at each end. The magnetic tape is belt-driven or advanced by rotation of the tape reels. As the magnetic tape is advanced, the magnetic tape is placed in longitudinal tension. Tension can cause the tape to stretch. This stretching is sometimes called “longitudinal creep.” Stretching, in addition to lengthening the magnetic tape, generally makes the magnetic tape narrower in its cross sectional dimensions due to the Poisson effect. This narrowing is sometimes called “latitudinal creep.” Another form of deformation is “telescoping,” in which a magnetic tape having one longer edge is wound onto a hub. Telescoping results in the magnetic tape tending to spiral toward one of the edges of the hub while it is being wound.

Deformation such as longitudinal creep, latitudinal creep and telescoping of the magnetic tape can disrupt the head-tape interface. The disruption can result in difficulty in positioning the head at the appropriate track of the magnetic tape, thus affecting the overall operation and performance of the drive. In particular, deformation can undermine the read and write operations performed by the drive. The inherent heat within the tape drive and/or associated equipment can heat the magnetic tape, making the tape more susceptible to deformation. Deformation is also problematic because the dimensions of magnetic tape can change over time. For example, magnetic tapes continually are made from thinner material so that more length of tape can be wound onto the hubs in a tape cartridge. Thinner tapes allow increased data capacity of a tape cartridge, but thinner tapes are also more susceptible to deformation under tension.

### SUMMARY

The present invention is directed toward the production and treatment of magnetic tape useful in data storage applications. In the course of production and ordinary use, magnetic tape is subjected to a variety of stresses that may tend to cause the tape to deform. Magnetic tape producing according to the present invention can be made more resistant to deformation ordinarily caused by such stresses.

When magnetic tape is wound onto a reel in a cassette or cartridge, the tape undergoes “pack stresses,” in which the tape is subjected to circumferential and radial stresses. Circumferential stresses are directed tangentially to the circumference of the tape winding. Radial stresses are directed perpendicularly to the circumferential stresses and through the center of the winding. Circumferential and radial stresses can change in a nonlinear fashion as the magnetic tape is wound. In use, magnetic tape may also be subjected to a variety of stresses that will change from one segment to another. As a result, different segments of a single tape on a single reel are subjected to different stresses and may deform in different ways according to these stresses, producing longitudinal, latitudinal, or telescoping deformation.

Ideally, the magnetic tape should not deform at all, but as a practical matter, some deformation is inevitable. In accordance with embodiments of the invention, magnetic tape is treated to produce tape that undergoes less deformation than untreated magnetic tape. As an additional advantage, deformation in the treated magnetic tape can be made smaller and more uniform along the entire length than untreated magnetic tape.

In one embodiment, the present invention provides a method comprising applying longitudinal tension to magnetic tape and simultaneously applying heat to the magnetic tape. The heat can be radiant heat, supplied by a device such as a lamp. In addition, a characteristic of the magnetic tape, such as the tape's temperature, can be measured following heating, and the application of heat controlled using the results of the measurement.

In another embodiment, the present invention provides a method comprising applying longitudinal tension to a base film following extrusion, simultaneously applying heat to the base film, and applying a magnetic coating to the base film.

In a further embodiment, the present invention provides an apparatus for treating a segment of magnetic tape, comprising a heating element and tension apparatus for applying longitudinal tension to a segment of the magnetic tape. The heating element applies heat to at least a portion of the segment of magnetic tape and the tension apparatus simultaneously applies longitudinal tension to the segment of the magnetic tape. The heating element may be a source of radiant heat, such as a lamp. The apparatus may also include a measuring device, configured to measure the heat applied by the heating element, by measuring a characteristic such as temperature. The apparatus may further comprise a controller coupled to the measuring device and to the heating element, the controller being configured regulate the heating element based upon a signal received from the measuring device. In addition, the apparatus may include a first reel that dispenses tape and a second reel that takes up the tape.

In a third embodiment, the invention provides an article of manufacture comprising magnetic tape. The magnetic tape undergoes a process comprising applying longitudinal tension to the magnetic tape and simultaneously applying heat to the magnetic tape.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an apparatus for treating magnetic tape consistent with an embodiment of the invention.

FIG. 2 is a graph showing longitudinal creep of test loops as a function of loop passes and tape temperature.

FIG. 3 is a flow chart illustrating a method for treating magnetic tape consistent with an embodiment of the invention.

### DETAILED DESCRIPTION

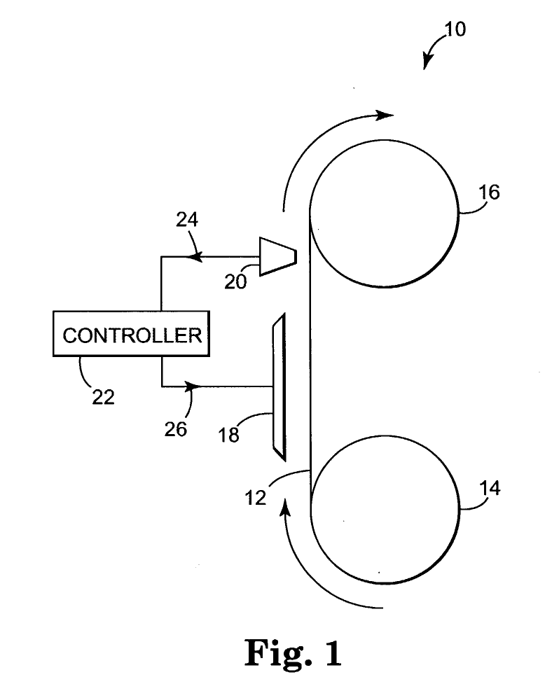

FIG. 1 is a diagram illustrating an embodiment of the invention, depicting an apparatus 10 for heat-treating magnetic tape under tension. A segment of magnetic tape 12 is shown in longitudinal tension between a first reel 14 and a second reel 16. While the segment of magnetic tape 12 is in longitudinal tension, heat is simultaneously applied to the magnetic tape 12 by a heating element 18. A measuring device 20 measures a characteristic of the tape after heating. A typical measuring device is an infrared temperature gauge, which measures the temperature of the tape. The measurement taken by the measuring device 20 indicates whether the magnetic tape 12 has been heat-treated to the appropriate degree. Readings from the measuring device 20 can be supplied as signals 24 to a controller 22, which can regulate 26 the heating element 18 based upon the signals, increasing or decreasing the applied heat as needed.

The segment of magnetic tape 12 undergoing treatment is typically a portion of a longer quantity of magnetic tape. The tape may be dispensed from the first reel 14 and may be taken up by the second reel 16. In this arrangement, the segment of magnetic tape 12 undergoing treatment changes as tape is dispensed from the first reel 14 and taken up by the second reel 16. In this manner, tape 12 can be moved between reels 14 and 16 to treat a continuous series of tape segments, thereby treating the entire length of tape.

The segment of magnetic tape 12 can be placed in longitudinal tension in many ways, such as by controlling the rate at which the magnetic tape is fed from the first reel 14, or controlling the rate at which the magnetic tape is taken up by the second reel 16. In preferred embodiments, the amount of tension is constant. However, variation in the degree of tension applied to the tape during treatment is conceivable. A suitable tension may within the expected range of operating tension applied to the tape. If, for example, the tape is expected to be under four ounces (1.1 N) of tension during normal use, then the tape may be subjected to approximately four ounces of tension during heat treatment. A suitable tension may also depend upon the width of the tape, with wider tapes able to bear greater tension without deformation. In general, magnetic tape can tolerate tensions of approximately ½ pound per inch of tape width (0.876 N per cm of width). Not only may the operating tension be incorporated into the heat-treatment apparatus 10, but the operating speed may be incorporated as well. So, for example, if the normal speed of the magnetic tape past a head is two meters per second, then the speed of magnetic tape 12 as it passes by the heating element 18 may be two meters per second. Alternatively, the magnetic tape may move at a typical rewind speed, such as 16 meters per second.

The heat treatment ordinarily takes place before the tape is packed in a cassette or a cartridge. The magnetic tape 12 undergoing heat treatment may be stock tape, that is, tape that has not been cut to width or “slit” for use. A reel of stock tape may be cut into many spools of tape. Although the heat treatment may be applied to individual spools of tape, it is more efficient to heat-treat stock tape rather than individual spools of tape. After treatment, the stock tape may be cut to width and length, and the cut tape may be spooled on individual reels and/or in single or dual reel tape cassettes/cartridges. The reels, cassettes or cartridges may then be used by a consumer.

Although FIG. 1 depicts an apparatus 10 for heat-treating magnetic tape 12 under tension, the apparatus may be used to heat-treat a precursor to magnetic tape as well. For example, the apparatus may heat treat base film. After the base film has been extruded, but before any coating is applied, the base film may be heat-treated under tension. Alternatively, the apparatus may be used to heat-treat the base film after some coating has been applied.

A typical heating element 18 is a lamp, which provides radiant heat and which can be easily regulated by controller 22. Heat can also be supplied by a heating element 18 that operates by convection or conduction as well. Examples include heating with an electrical elements; heating with warm air blown by a fan, feeding the tape 12 across a heated roller, and the like.

A typical measuring device 20 is a temperature gauge, which measures the temperature of the tape following heating. The measuring device 20 may measure characteristics of the magnetic tape 12 other than temperature, such as the physical dimensions of the magnetic tape 12 upon heating. Deformation such as lateral creep and longitudinal creep may also be measured. While the tape 12 undergoes heating while in tension, the tape typically experiences some longitudinal creep. Tape heated at 80 degrees Celsius, for example, generally lengthens by about 330 parts per million, and the tape does not thereafter recover its original dimensions. Dimensional measurements may be obtained, for example, using self-scanned optical arrays and the like, or by measuring the difference in speed between the winding up and the unwinding of the tape. The results of the measurement can be used to control the application of heat to the magnetic tape, as measuring device 20 can supply feedback signals to controller 22, which can regulate the heating element 18.

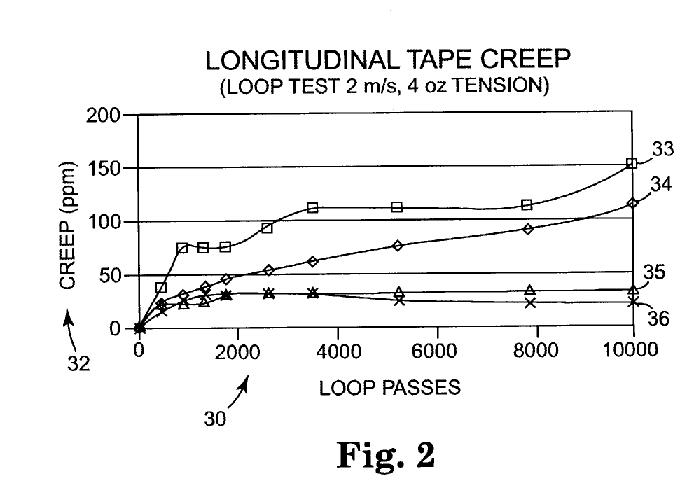

FIG. 2 depicts the results of testing loops of one-half inch (1.3 cm) magnetic tape that had been placed in tension and heated to different temperatures prior to testing in accordance with the present invention. The results demonstrate that magnetic tape that has been so treated as described above will deform less during actual use. The results also suggest a useful range of tape temperatures during the treatment.

As shown in FIG. 2, four test tapes underwent several loop passes. The loop passes generally simulate tape usage over time, with 10,000 loop passes representing approximately two hours of continuous use. The horizontal axis 30 depicts the number of loop passes. The vertical axis 32 depicts the measured longitudinal creep in parts per million. (The longitudinal creep being measured does not include longitudinal creep that the tape may have experienced during heat treatment.) Ideally, a tape should show no longitudinal creep. As a practical matter, however, having a tape with very little longitudinal creep is more desirable than having one with pronounced longitudinal creep, and having a tape that maintains a constant deformation during use is more desirable than having one that continues to deform over time.

As a control, one test tape (designated in FIG. 2 by a square 33) was placed in tension but was maintained at ambient temperature and was not heated with a heating element prior to testing. In testing, this control tape showed considerable longitudinal creep following use. The control tape further demonstrated deformation that changed over time. A second test tape (designated in FIG. 2 by a diamond 34) that had been heated to 60 degrees Celsius showed less longitudinal creep than the unheated tape, but the longitudinal creep was nevertheless considerable and increased over time. Test tapes heated to 80 degrees Celsius (designated in FIG. 2 by a triangle square 35) and 100 degrees Celsius (designated in FIG. 2 by a cross 36), however, showed comparatively little longitudinal creep. Moreover, after 2,000 passes the deformation of test tapes heated to 80 degrees and 100 degrees Celsius was nearly constant. Because magnetic tape of particular dimensions generally has a positive Poisson's ratio regardless of temperature, reducing longitudinal creep will reduce lateral creep as well.

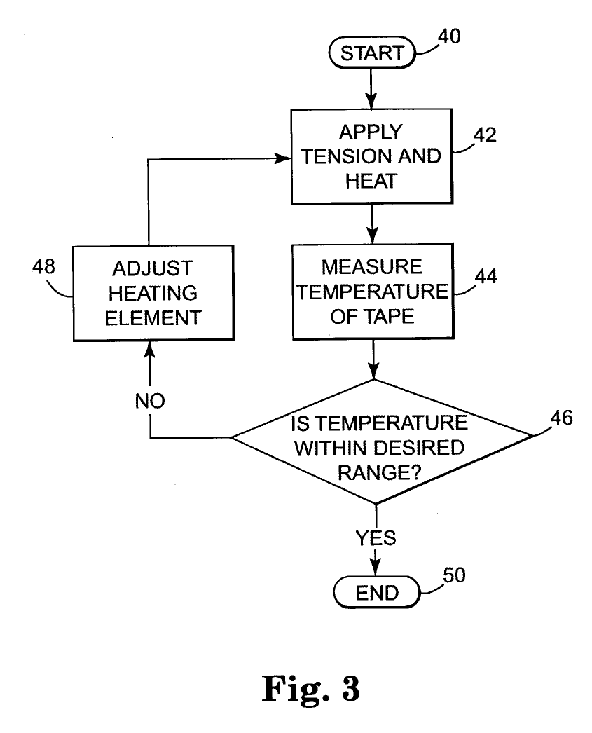

FIG. 3 depicts an embodiment of the invention as a process. A segment of magnetic tape enters the process (40) without having been heat-treated. The segment is placed in tension and heat is applied (42). Thereafter, the temperature of the tape is measured (44) to determine if the desired tape temperature has been reached (46). If the tape temperature is not within the desired temperature range, the heating element is adjusted (48) to increase or decrease the applied heat. Other embodiments are within the scope of the following claims.

1. A method of manufacturing a magnetic tape, the method comprising:
extruding a base film;
following extrusion, applying longitudinal tension to the base film;
applying heat to the base film simultaneously with the application of the longitudinal tension; and
coating the base film with a magnetic coating of iron oxide particles in a polymeric binder to form the magnetic tape.

2. The method of claim 1, further comprising applying the heat by radiation.

3. The method of claim 1, further comprising:
measuring a characteristic of the base film following heating,
wherein the characteristic is at least one of temperature, lateral creep and longitudinal creep.

4. The method of claim 3, further comprising controlling the application of heat to the base film based on the results of the measurement.

6. The method of claim 1, further comprising coating the base film with the magnetic coating after applying the longitudinal tension and heat to the base film.

7. The method of claim 1, wherein the tension has a magnitude of approximately 4 ounces (1.1 N).

8. The method of claim 1, wherein the tension has a magnitude of approximately ½ pound per inch of base film width (0.876 N per cm of width).

9. The method of claim 1, further comprising measuring a characteristic of the base film following heating, wherein the measured characteristic of the base film is temperature, the method further comprising applying heat to the base film such that the base film reaches a temperature between 80 and 100 degrees Celsius.
